(19) United States
(12) Patent Application Publication
(10) Pub. No.: US 2026/0134199 A1
(43) Pub. Date: May 14, 2026

(54) AUTOMATIC DETECTION OF NON-HUMAN AUTHORED CONTENT IN ELECTRONIC DOCUMENTS

(71) Applicant: Superhuman Platform Inc., San Francisco, CA (US)

(72) Inventors: Dhruv Matani, Newark, CA (US); Ihor Skliarevskyi, Vancouver (CA); Ryan Grimm, Pacifica, CA (US); Mike Henkel, San Anselmo, CA (US); Alex Shevchenko, San Francisco, CA (US); Cliff Archey, Austin, TX (US); John Blatz, San Francisco, CA (US); Vlad Nykytiuk, San Francisco, CA (US); Suwen Zhu, New York, NY (US); Ankit Garg, San Francisco, CA (US); Jennifer Van Dam, San Francisco, CA (US)

(21) Appl. No.: 19/387,327

(22) Filed: Nov. 12, 2025

Related U.S. Application Data
(60) Provisional application No. 63/719,876, filed on Nov. 13, 2024.

(51) Int. Cl. G06F 40/166; G06F 40/40; G06T 11/20

(52) U.S. Cl. CPC G06F 40/166; G06T 11/26; G06F 40/40

(57) ABSTRACT

A technique for determining authorship of a document is disclosed. The technique includes a method which comprises monitoring, by a computer system, interactions of a user with the computer system during a process of using the computer system to create a document. The method further comprises determining, by the computer system, a source authorship for each of a plurality of text units of the document by using metadata obtained from the monitoring, wherein the determining is performed during the process of using the computer system to create the document. The method further comprises causing, by the computer system, generation of a report indicative of the source of authorship for each of the plurality of text units of the document, based on results of the determining.

This application claims the benefit of U.S. provisional patent application No. 63/719,876, filed on Nov. 13, 2024 and titled, “AUTOMATIC DETECTION OF NON-HUMAN AUTHORED CONTENT IN ELECTRONIC DOCUMENTS,” which is incorporated by reference herein in its entirety.

### COPYRIGHT NOTICE

A portion of this patent document's disclosure contains material subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2024, 2025 Superhuman Platform Inc.

### TECHNICAL FIELD

One technical field of the present disclosure is computer-implemented natural language processing. Another technical field is natural language text addition, modification, or suggestion. The suggested CPC classification is G06F40/40 and G06N5/04.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Computer-implemented generative artificial intelligence (AI) systems, including generative AI software and systems capable of automatically generating text content in response to a prompt based on trained machine learning models like large language models (LLMs), have entered wide use. These systems are now so good at mimicking human natural language written composition that people typically cannot determine, given a digital electronic text document, whether another human or a machine authored the document's content. Consequently, consumers and readers of electronic digital documents, including but not limited to the academic and business communities, need automated computer-implemented tools to detect plagiarism and non-human composition. Thus, the specific relevant technical problem is how to program a computer to receive an arbitrary digital electronic text as an input, determine what systems contributed to the input at the time of creation or composition, and output a report, alerts, notifications, or other data representing the sources that were used to create the input text.

One commercial solution detects plagiarism via analysis of an existing sample of input text, solely of based on the writing style of the input text. However, today's generative AI systems can duplicate most human writing styles, rendering the solution ineffective. Existing plagiarism and AI detection tools also typically have a minimum character count requirement because their detection operations cannot operate on a text document that is too short, which can render the tools ineffective for certain domains or document types.

Based on the foregoing, there is an acute need in the relevant technical fields for a computer-implemented, high-speed online system with real-time response capable of inspecting an input text, determining what systems contributed to the input at the time of creation or composition, and output a report, alerts, notifications, or other data representing the sources that were used to create the input text.

### BRIEF DESCRIPTION OF THE DRAWINGS

One or more implementations of the present disclosure are illustrated by way of example and not limitation in the figures of the accompanying drawings, in which like references indicate similar elements.

FIG. 1 illustrates a distributed computer system showing the context of use and principal functional elements with which one embodiment could be implemented.

FIG. 2 illustrates a computer-implemented process of && in one embodiment.

FIG. 3A illustrates an example of a computer display device showing a graphical user interface displaying an authorship report.

FIG. 3B illustrates an example of a computer display device showing a graphical user interface displaying a document with provenance information associated with sentences.

FIG. 3C illustrates a first example of a computer display device showing a portion of a graphical user interface displaying a document, a provenance card, and other provenance information.

FIG. 3D illustrates a second example of a computer display device showing a portion of a graphical user interface displaying a document, a provenance card, and other provenance information.

FIG. 3E illustrates an example of a computer display device showing a graphical user interface displaying a document with a graphical authorship bar and a provenance card and other provenance information.

FIG. 3F illustrates an example of computer graphical displays of user interface panels for controlling authorship tracking operations.

FIG. 3G illustrates an example of a computer display device showing a portion of a graphical user interface with report-sharing controls.

FIG. 3H illustrates a first example of computer-generated graphical cards for displaying authorship data.

FIG. 3J illustrates a second example of computer-generated graphical cards for displaying authorship data.

FIG. 3K illustrates a third example of computer-generated graphical cards for displaying authorship data.

FIG. 4 illustrates an example of a computer system that can be used with one embodiment.

FIG. 5 is a flowchart showing an example of a process in accordance with a technique for determining authorship of text entered into an electronic document.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

The following description outlines numerous details to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

Embodiments are described in the sections below according to the following outline:
1. General Overview
2. Structural & Functional Overview
3. Implementation Example

### 1. General Overview

Based on the foregoing, there is an acute need in the relevant technical fields for a computer-implemented, high-speed online system with real-time response capable of inspecting an input text, determining what systems contributed to the input at the time of creation or composition, and output a report, alerts, notifications, or other data representing the sources that were used to create the input text. In an embodiment, a computer-implemented process is programmed to determine what sources/systems contributed to the input at the time of creation or composition based on monitoring the technical processes by which the original text was created, for example, by tracking whether each unit of text was typed directly using a computer or copied from another source, including but not limited to AI sources. Embodiments can be used in academic or educational domains, publishers, media companies, government, and any other enterprise or entity that develops content that needs to be copyrighted or demonstrated as human-authored or human-generated. Embodiments work in all applications and locations, including but not limited to browser web form windows, where users write text. Embodiments work on multiple platforms, including but not limited to Microsoft Windows and MacOS. Embodiments are programmed to gracefully process instances in which documents are edited in multiple discrete sessions over time, tracking text as it moves between applications and documents. While embodiments are programmed to inspect keystrokes and other events, such as copy-paste operations, embodiments can execute fully on-device to support user privacy.

One embodiment is programmed to receive a digital electronic text and output a report providing a detailed analysis of the text showing the percentage of text that was typed, generated by AI, or modified by assistive technology, as the case may be. In one embodiment, on-device software is programmed to track the origin of every piece of text in a document. For instance, an embodiment can distinguish text typed by the user, content pasted from external sources like such as a generative AI (“GenAI”) large language model (LLM) (e.g., ChatGPT, Gemini, Claude, or the like), and text revised through suggestions of a writing assistant such as Grammarly. In one embodiment, using the report, a writer can demonstrate the authenticity of their work transparently and objectively, detailing the extent of generative tool usage in compliance with institutional or enterprise guidelines.

Conventional plagiarism detection tools are purely result-oriented in that they work only after the fact, i.e., after a sample of text document has been written. In contrast, the technique introduced here is process-oriented, i.e., it works to determine authorship of text in real-time as the text is being written, by tracking in real-time the actions of the user and/or the system being used to create the text. To that extent, the technique introduced here can gain significantly more insight into the manner and source(s) of authorship than conventional plagiarism detection tools.

In one embodiment, a computer-implemented process executes using a first software component on an end-user computing device and a second software component on a server to which the computing device is coupled via a telecommunications network. The first software component is programmed to obtain digital electronic text in a GUI panel, window, document, or other location, via an application programming interface (API) of an operating system (OS) or other software components executing on the computing device. For brevity and convenience, this disclosure may refer to the GUI panel, window, document, or other location where text is entered as a “document.”

The first software component may obtain at least some of the input text via a core API of a browser and/or via an accessibility API of the OS. For example, in some embodiments, the first software component is a plug-in of a browser and obtains at least some of the input text via the browser's core API relating to browser keystroke events. In other embodiments, the first software component is, or is part of, a stand-alone software application and obtains at least some of the input text via an accessibility API of the OS on which the first software component runs.

In response to detecting that a unit of text is entered into the document, the first and second software components cooperate to record the way or means by which the text was generated, termed its “provenance,” in a database indexed by a document ID, and recorded on a per-character basis along with an identifier for the atomic edit operation. In a relatively simple embodiment, the first and second software components may implement provenance classification logic in one embodiment according to the following steps. If a text unit was typed using a real keyboard input method character-by-character, record it as human-written. If the text unit was written by an identifiable application or service, such as Grammarly, record an identifier of the application or service. If the text unit was pasted, record it as sourced from generative artificial intelligence (Gen AI) if it came from a known Gen AI source or as sourced from a specific website if it came from a known website, and record it as unattributed otherwise.

In an embodiment, when a copy event occurs, provenance classification is performed at the time of the copy event, and an indication of the provenance is temporarily stored in an application variable using the first software component on the computing device, and is copied into the destination document when a paste operation occurs. The first software component can use an API to detect all on-device operations (e.g., an accessibility API of the OS), and consequently, the first software component can reliably observe all copy/paste operations. Therefore, the above-mentioned process works correctly within documents and across documents and applications.

In one embodiment, user input in a user interface panel that the browser extension associated with the first software component generates can signal a request to create a report. In response, the first software component transmits the document's text, the above-mentioned provenance data above, and the history of edit events over the network to the second software component. The second software component is programmed to assemble this data into a report without performing provenance computation.

In an embodiment, the provenance value “unattributed” can be used when the architecture or operation of a particular word processing application does not permit detecting a copy operation, paste operation, or other events, or when the provenance otherwise cannot be determined with high confidence. In one embodiment, the first software component can include various adapters for different generative AI producers to interoperate with the specifics of their APIs or UIs.

Embodiments can be programmed to support user privacy. For example, various embodiments can provide notifications or alerts to a user that the system is programmed to perform on-device storage of an online document in the form of records in the provenance database that correspond to keypresses in the online document. Embodiments can be programmed to provide a user control to delete the records from the device. Embodiments can be programmed to implement a default retention period and perform encryption of the provenance table. Embodiments can be programmed to prompt the user to decide before they log out or end a session, whether to retain the contents of the provenance table or delete records in the table. Alternatively, embodiments can be programmed to automatically de-identify or delete records in the provenance table after a specified retention period, such as 30 days after a logout. Embodiments can be programmed to provide periodic visual or aural messages, notifications, or alerts specifying that storage of events and keypresses in the provenance table is occurring.

Embodiments can be programmed to include a complete document and its editing history in a provenance or authorship report. Embodiments can be programmed to prompt users to review the report before distributing it to others.

### 2. Structural & Functional Overview

### 2.1 Text Provenance Processing

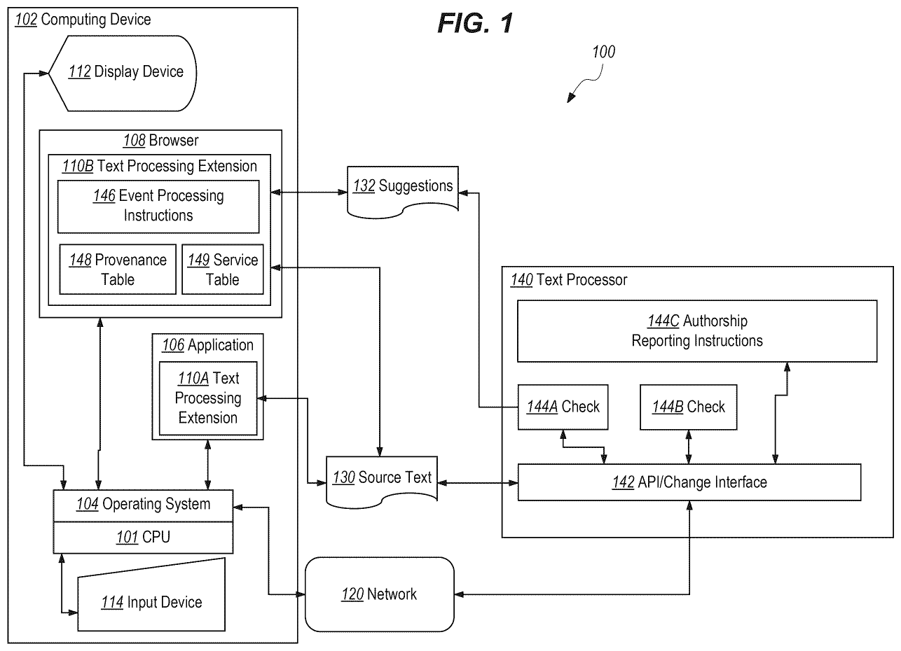

FIG. 1 illustrates a distributed computer system showing the context of use and principal functional elements with which one embodiment of the technique introduced here could be implemented. In an embodiment, a computer system 100 comprises components implemented partially by hardware at one or more computing devices, such as one or more hardware processors executing stored program instructions stored in memory for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1 and the other drawing figures and all of the description and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

An embodiment can be integrated or used with a writing assistant system capable of receiving the changed text of a document and providing suggestions for changing the document to improve grammar, style, correctness, tone, or other writing attributes. Other embodiments can be implemented as a provenance or authorship reporting system independent of a writing system. In the example of FIG. 1, a computing device 102 is communicatively coupled via a network 120 to a text processor 140. In one embodiment, computing device 102 comprises a client-type computing device such as a personal computer, laptop, tablet, smartphone, or notebook computer. The text processor 140 can execute on a server computer or virtual compute instance configured as a server. For purposes of illustrating a clear example, a single computing device 102, network 120, and text processor 140 are shown in FIG. 1, but practical embodiments may include thousands to millions of computing devices 102 distributed over a wide geographic area or over the globe, and hundreds to thousands of instances of text processor 140 to serve requests and computing requirements of the computing devices.

Computing device 102 comprises, in one embodiment, a central processing unit (CPU) 101 coupled via a bus to a display device 112 and an input device 114. In some embodiments, display devices 112 and input devices 114 are integrated; for example, a touch-sensitive screen is used to implement a soft keyboard. CPU 101 hosts operating system 104, including a kernel, primitive services, a networking stack, an accessibility API or service, and similar foundation elements implemented in software, firmware, or a combination. Operating system 104 supervises and manages one or more other programs. For a clear example, FIG. 1 shows the operating system 104 coupled to an application 106 and a browser 108, but other embodiments may have more or fewer apps or applications hosted on computing device 102. Embodiments can interoperate with either a browser or an application and the use of a browser is not required.

At runtime, one or more of application 106 and browser 108 loads, or is installed with, a text processing extension 110A, 110B, which comprises executable instructions that are compatible with text processor 140 and may implement application-specific communication protocols to rapidly communicate text-related commands and data between the extension and the text processor. Text processing extensions 110A and 110B may be implemented as runtime libraries, browser plug-ins, browser extensions, or other means of adding external functionality to otherwise unrelated third-party applications or software. For example, CHROME browser extensions can be programmed. The precise means of implementing a text processing extension 110A or 110B or obtaining input text is not critical, provided an extension is compatible with and can be functionally integrated with a host application 106 or browser 108. Browser 108 can be used with any of various online applications, such as Google Docs, Microsoft Word, ChatGPT, and Microsoft Copilot.

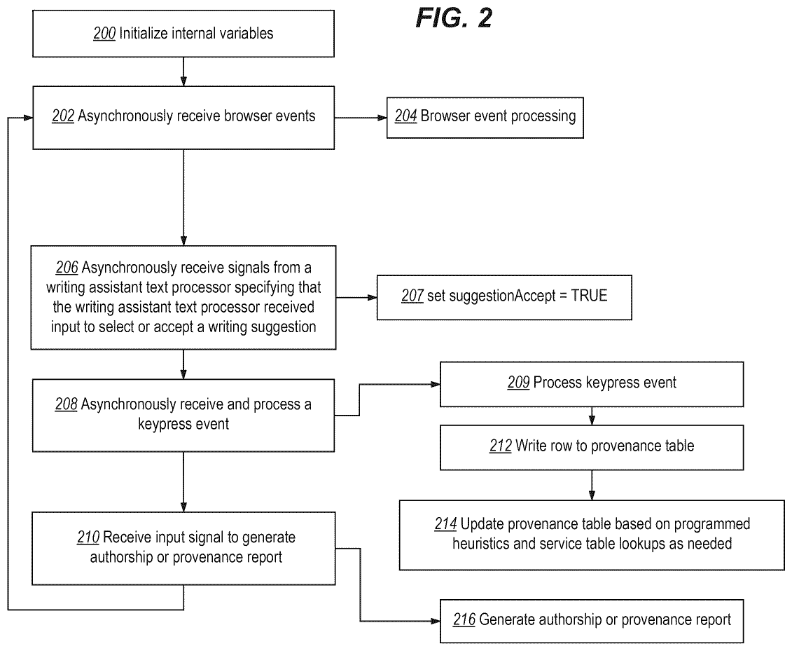

In some embodiments, a text processing extension 110A may be installed as a stand-alone application that communicates programmatically with the operating system 104 and with an application 106. For example, in one implementation, text processing extension 110A executes independently of application 106 and programmatically calls services or APIs of operating system 104 to obtain the text that has been entered in or that is being entered in input fields that the application 106 manages. Accessibility services or accessibility APIs of the operating system 104 may be called for this purpose; for example, an embodiment can call an accessibility API that normally obtains input text from the application 106 and outputs speech to audibly speak the text to the user but uses the text obtained by the accessibility service in the processes that are described for FIG. 2 and other sections herein. The text processing extension 110B, shown as hosted via the browser 108, can also use programmatic calls to access the same accessibility services. Techniques for using accessibility APIs to obtain, read, and highlight text in any application on the screen of any computing device with an operating system or other service that exposes the accessibility API are disclosed in, for example, U.S. Pat. Nos. 11,880,644 and 11,468,227, the entire contents of which are hereby incorporated by reference for all purposes as if fully set forth herein.

In some embodiments, each text processing extension 110A, 110B is linked, loaded with, or otherwise programmatically coupled to or with one or more of application 106 and browser 108 and, in this configuration, can use API calls, internal methods or functions, or other programmatic facilities of the application or browser. These calls or other invocations of methods or functions enable each text processing extension 110A, 110B to detect text that is entered in input fields, windows, or panels of application 106 or browser 108, instruct the application or browser to delete a character, word, sentence, or another unit of text, and instruct the application or browser to insert a character, word, sentence, or another unit of text.

Each of the text processing extensions 110A and 110B is programmed to interoperate with a host application 106 or browser 108 to detect the entry of text in a text entry function of the application or browser and/or changes in the entered text, to transmit changes in the text to text processor 140 for server-side checking and processing, to receive responsive data and commands from the text processor, and to execute presentation functions in cooperation with the host application or browser. The text processing extensions 110A and 110B can subscribe to browser events, accessibility events, or calls of an accessibility service or API.

As one functional example, assume that browser 108 renders an HTML document with a text entry panel where a user can enter free-form text describing a product or service. The text processing extension 110B is programmed to detect text entry, user selection of the text entry panel, or changes in the text within the panel and to transmit all such text changes to text processor 140. In an embodiment, each text processing extension 110A, 110B is programmed to buffer or accumulate text changes locally over a programmable period, for example, five seconds, and transmit the accumulated changes over that period as a batch to text processor 140. While not required, buffering or accumulation in this manner may improve performance by reducing network messaging roundtrips and reducing the likelihood that text changes could be lost due to packet drops in the networking infrastructure. A commercial example of text processing extensions 110A and 110B is the GRAMMARLY extension, commercially available from Superhuman Platform Inc. (formerly known as Grammarly, Inc.).

Network 120 broadly represents one or more local area networks, wide area networks, campus networks, or internetworks in any combination, using terrestrial, satellite, wired, or wireless network links.

In an embodiment, the text processor 140 comprises one or more server computers, workstations, computing clusters, and/or virtual machine processor instances, with or without network-attached storage or directly attached storage, located in any of enterprise premises, private data center, public data center and/or cloud computing center. Text processor 140 broadly represents a programmed server computer with processing throughput and storage capacity sufficient to communicate concurrently with thousands to millions of computing devices 102 associated with different users or accounts. For purposes of illustrating a clear example and focusing on innovations that are relevant to the appended claims, FIG. 1 omits basic hardware elements of text processor 140, such as a CPU, bus, I/O devices, main memory, and the like, illustrating instead an example software architecture for functional elements that execute on the hardware elements. Text processor 140 also may include foundational software elements not shown in FIG. 1, such as an operating system consisting of a kernel and primitive services, system services, a networking stack, an HTTP server, other presentation software, and other application software. Thus, text processor 140 may execute on a first computer, and text processing extensions 110A and 110B may execute on a second computer.

In an embodiment, text processor 140 comprises an API/change interface 142 that is coupled indirectly to network 120. API/change interface 142 is programmed to receive the text changes that text processing extensions 110A and 110B transmit to text processor 140 and to distribute the text changes to a plurality of different checks 144A and 144B. To illustrate a clear example, source text 130 of FIG. 1 represents one or more text changes that text processing extension 110B transmits to change interface 142. In an embodiment, change interface 142 is programmed to distribute every text change from a text processing extension 110A, 110B to all of the checks 144A and 144B, which execute in parallel and/or independent threads.

Thus, in one embodiment, the text processor 140 may be programmed to programmatically receive a digital electronic object comprising a source text, a message with the source text, an application protocol message with the source text, an HTTP POST request with the source text as a payload or using other programmed mechanics. In various embodiments, the first computer executes a text processor that is communicatively coupled to a text processor extension that is executed at the second computer and programmatically receives the digital electronic object comprising the source text via a message initiated at the text processor extension and transmitted to the text processor; and/or the text processor extension executes in association with an application program that is executing at the second computer, the text processor extension being programmed to automatically detect a change in a text entry window of the application program and, in response, to initiate the message; and/or the text processor executes in association with a browser that is executing at the second computer, the text processor extension being programmed to automatically detect a change in a text entry widget of the browser and, in response, to initiate the message.

Each of the checks 144A and 144B is programmed to execute a different form of checking or processing of a text change that has arrived. Example functions that the checks 144A and 144B could implement include grammar checking, tone detection, and translation.

In an embodiment, one or both of text processing extension 110A and text processing extension 110B is programmed as an element of an authorship or provenance determination and reporting system and comprises event processing instructions 146 coupled to or capable of accessing a provenance table 148 and a service table 149 stored in on-device memory. To simplify this description, functions related to the authorship or provenance determination reporting system are described herein as being performed by text processing extension 110B, but it should be understood that the same or similar functions can additionally or alternatively be performed by text processing extension 110A. Additionally, while text processing extensions 110A and 110B are described herein as having the ability to perform and/or facilitate various checks such as grammar checking, tone detection, and translation, as described above, in some embodiments they do not perform such checks and only perform functions described herein related to authorship or provenance determination and reporting.

In an embodiment, the event processing instructions 146 are programmed to receive keypresses, browser events, or functionally equivalent data, interpret the event data or keypress, and to write or update records in the provenance table 148.

Service table 149 comprises a stored mapping of URLs or other network addresses to service labels. An example of a service label is “ChatGPT.” The service table 149 serves as a repository of known services that could be sources of text automatically generated or pasted into a document that the browser 108 is accessing and the computing device 102 is updating or working on. Service labels can comprise names of commercial or non-commercial third-party services, websites, or other networked resources, including generative AI services or other applications.

The event processing instructions 146 are also programmed to generate one or more user interface windows, panels, or widgets that expose options, functions, or selections. In one embodiment, a user interface panel includes a widget programmed to request reporting instructions 150 of text processor 140 to generate an authorship report or provenance report based on data in provenance table 148. Specific functionality is described further in other sections herein.

### 2.2 Event and Keypress Processing

FIG. 2 illustrates a computer-implemented process of classifying a source text, determining phrase suggestions, and presenting the phrase suggestions in one embodiment. FIG. 2 and each other flow diagram herein are intended to illustrate the functional level at which skilled persons, in the art to which this disclosure pertains, communicate with one another to describe and implement algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

The description of FIG. 2 herein assumes that a first software component is installed on a user computing device; for example, either of text processing extension 110A or text processing extension 110B can correspond to the first software component, and the user computing device can be computing device 102 of FIG. 1. The first software component launches, subscribes to events published by an API (e.g., the browser's core API relating to browser keystroke events or an accessibility API of operating system 104) or other system service, allocates memory to store an on-device provenance database using application managed storage (e.g., browser-managed storage in an embodiment where the first software component is text processing extension 110B), and accesses a previously created service mapping table. Assume further that a user executes a text preparation program, for example, Google Docs, using the browser 108 or a local application such as the Microsoft Word client. Subsequently, the process of FIG. 2 can process keypresses or events occurring during the use of the text preparation program.

At step 200 of FIG. 2, the process is programmed to initialize internal variables. To illustrate a clear example, assume that step 200 comprises instructions to set variables labeled suggestionAccept=FALSE, lastURLaccessed=NULL, copyEventOccurred=FALSE. Different embodiments can use different labels for functionally equivalent data storage, and the foregoing labels are not required.

At step 202, the process is programmed to asynchronously receive browser events or events that another application publishes (hereinafter simply “browser events” to simplify description). “Asynchronously” in this context means that step 202 and other steps that are specified as asynchronous can occur at any time during a document preparation session, and the process of FIG. 2 will respond as described; that is, the process of FIG. 2 does not need to follow a sequential flow in the order indicated and the processing operations of other steps can occur whenever a particular type of event, signal, or input is received.

When a browser event is received at step 202, in response, at step 204, event processing executes. For example, in some embodiments, if the browser event is “new tab created” or “tab selected,” and an HTTP GET occurs, the process is programmed to store the URL of the HTTP GET payload as the value of the variable lastURLaccessed. Browser events other than “new tab created” or “tab selected” can trigger different processing.

At step 206, the process is programmed to asynchronously receive signals from a writing assistant text processor specifying that the writing assistant text processor received input to select or accept a writing suggestion and set the value of the variable suggestionAccept=TRUE at step 207. For example, assume that the text processing extension 110B transmitted the source text 130 of the current document to check 144A of text processor 140, which is programmed as a spelling correctness checker, and received text suggestions 132 in response, where the text suggestions comprise a set of spelling corrections. In response, the text processing extension 110B can be programmed to display the suggestions in a current window showing the current document and receive an input signal from input device 114, indicating that the user has accepted the suggestions 132. In an embodiment, the event processing instructions 146 are programmed to observe the input signal and set the value of the variable suggestionAccept=TRUE. In this manner, the event processing instructions can determine that a particular sequence of characters that change in the current document resulted from check 144A, not from a generative AI source, a paste operation from another document, or an unattlibuted source.

At step 208, the process is programmed to asynchronously receive keypress events and currently tracked document change text events, hereinafter collectively referred to as “text change events.” Keypress events originating from user actions as opposed to other APIs (accessibility, application extensions, etc.) may be marked as trusted events by the first software component. In an embodiment, only trusted events are saved for processing in a local memory structure. A text change event can indicate a single or multiple character change or even words and text deletions due to the asynchronous nature of text change tracking implementation.

In response to receiving a text change event at step 208, control transfers to step 209 to process the text change. If the text change as a whole is deemed to match trusted keypress events storage, the whole text originating from the text-change event of the document is marked as human-written. Otherwise, additional checks are performed to match this text change with other known sources. The text from the text change event is then split by characters and added to the provenance table. For example, as shown in step 212, each character is written into a row of the provenance table 148. In an embodiment, each row of the provenance table 148 records a timestamp, the character, an ordinal position of the character in the document, a provenance label, and a provenance event value. Writing rows to the provenance table may require memory allocation operations, and, in general, the provenance table can enlarge to the limits of application storage (e.g., browser storage) that is capable of allocation. If an allocation error occurs, normal error messages are thrown. An example of one possible organization or schema for the provenance table 148 is as follows:

| | | Ordinal | | |
|---|---|---|---|---|
| | Char- | Position in | | Provenance |
| Timestamp | acter | Document | Provenance | Event Value |
| 16-Sep-2024 | F | 1 | Human typed | |
| 08:09:01:24 | | | | |
| 16-Sep-2024 | o | 2 | Human typed | |
| 08:09:02:24 | | | | |
| 16-Sep-2024 | r | 3 | Human typed | |
| 08:09:03:24 | | | | |
| 16-Sep-2024 | s | 4 | https://hemingURL.com/ | pastedFrom |
| 08:09:04:36 | | | six_word_story | |
| 16-Sep-2024 | a | 5 | https://hemingURL.com/ | pastedFrom |
| 08:09:04:37 | | | six_word_story | |
| 16-Sep-2024 | l | 6 | https://hemingURL.com/ | pastedFrom |
| 08:09:04:38 | | | six_word_story | |
| 16-Sep-2024 | e | 7 | https://hemingURL.com/ | pastedFrom |
| 08:09:04:39 | | | six_word_story | |
| 16-Sep-2024 | . | 8 | https://hemingURL.com/ | pastedFrom |
| 08:09:04:40 | | | six_word_story | |
| | B | 9 | ChatGPT | pastedFrom |
| | a | 10 | ChatGPT | pastedFrom |
| | b | 11 | ChatGPT | pastedFrom |
| | y | 12 | ChatGPT | pastedFrom |
| | - | 13 | ChatGPT | pastedFrom |
| | s | 14 | ChatGPT | |
| | h | 15 | ChatGPT | |
| | o | 16 | ChatGPT | |
| | e | 17 | ChatGPT | |
| | s | 18 | ChatGPT | |
| | I | 19 | ChatGPT | |
| | - | 20 | ChatGPT | |
| | n | 21 | ChatGPT | |
| | e | 22 | ChatGPT | |
| | v | 23 | ChatGPT | |
| | e | 24 | ChatGPT | |
| | r | 25 | ChatGPT | |
| | - | 26 | ChatGPT | |
| | w | 27 | ChatGPT | |
| | o | 28 | ChatGPT | |
| | r | 29 | ChatGPT | |
| | n | 30 | ChatGPT | |
| | | 31 | ChatGPT | |

Timestamps are omitted from some rows above for brevity. Embodiments can include other columns for provenance category values, service label values, and URLs. While the column above for the ordinal position of items shows only sequential values, table 148 can store multiple rows with the same ordinal position value; this allows tracking changes in text over time. For example, if a particular character is first typed and then modified using a generative AI system or a writing assistant, multiple rows can reflect both the first entry of a character and a later replacement of a character in the same ordinal position using an automated system. Thereafter, computational analysis of the data in the table can yield metrics and insights about how the authorship and provenance of the document changed or evolved.

Furthermore, at step 209, text change event processing can include special processing for text changes that represent operations rather than entering a character. For example, if the text change event indicates a non-human typed operation, the process is programmed to set the value of a variable called nonHumanTypedEventOccured=TRUE. In some embodiments, the process is programmed to read the clipboard maintained in system storage and to copy and store metadata of the clipboard, including a value of any URL used when the copy option occurred; this functionality enables associating a copy operation with a website, service, or other source where the copy operation occurred so that a later paste operation can be attributed to that source. The processing of URLs is described later for subsequent steps.

Similarly, at step 214, the provenance table can be updated based on one or more other programmed heuristics. For example, an embodiment can be programmed to update the provenance table using the following approach:
1. If the text change event indicates that some text was deleted, update the provenance table 148 and the ordinal position of text accordingly after the deletion is updated.
2. If the text change event indicates the addition of one or more characters, nonHumanTypedEventOccured=TRUE, and the text matches previously saved content of the operating system Clipboard, then store “pastedFrom” as the provenance event value. This rule detects a copy-paste operation, and other logic can ascribe a provenance or attribution to the source of the copied text.
3. If suggestionAccept=TRUE, store a writing assistant identifier as the provenance label. This rule detects that the writing assistant software was the source of the text. In this case, the pasted text is the same as or equivalent to text that the writing assistant automatically supplied.
4. If a URL value has been stored, check the stored URL value against the service table 149. If a matching service label exists in the service table 149, store the matching service label as in the provenance label as the provenance attribute, to attribute the paste operation to that service. If no matching service label exists, store “Unattributed” as the provenance label. This programmed rule detects a paste operation and attributes the paste operation to a particular service, if known. Also, if the user performed a copy operation, and the event did not result from the text processor 140 providing a suggestion, then the source of the keypress is unknown or unattributed to a specific source.
5. If the URL matches a service label in the service table 149, and the service label is ChatGPT or another known GenAI tool, optionally capture (e.g., via an accessibility API of the OS), the prompt that the user used and write the prompt to storage for use in the report. The provenance table can include a prompt column for this purpose.

In an embodiment, copying text to the system clipboard is the trigger for storing the text in association with the URL to a local application-specific storage buffer. For example, any user action (e.g., click or keypress) that leads to a change in clipboard content is a trigger to store that content in the storage buffer for further attribution. Subsequently, the next paste event triggers associating the copied-and-pasted text with the URL in the provenance table.

Although the typing pace, time between keypresses and/or difference in such time during typing session generally is not used to determine determinative of human-type provenance or the lack thereof, the time metrics are related to text input can be analyzed to present additional signals in the report via an “Unnatural typing” visual or graphical card in the display. The threshold value specified for determining whether typing is “unnatural” can vary in different embodiments. Examples include 80 ms per character, 40 ms per character, or another value sufficiently short to represent suggest a software-based paste operation and thus shorter than the inter-character entry time of the fastest human typist. For example, typing at the world record speed of 300 WPM equals about 1,500 characters per 60 seconds, 25 characters per second, or 40 ms per character.

Any of various provenance categories may be identified by the first software component, such as keypresses, websites, other applications, and GenAI tools. Additionally, one or more provenance categories may be defined as a combination of two or more other provenance categories, such as “GenAI but edited by Grammarly” or “pasted and typed.”

In embodiments where the first software component is a browser (e.g., browser 108), the browser may use one or more APIs, such as its core API relating to browser keystroke events, to identify user keypresses as the source of text. For example, a browser may use one or more of the following system APIs to identify the source of text: IndexedDB API, Web Crypto API, Clipboard API, Permissions API, Document API, Selection API, Document Visibility API or Window API.

On the other hand, where the first software component is (or is part of) an application other than a browser, the first software component may use an accessibility API of the underlying operating system to identify user keystrokes. For example, for a Windows operating system, the first software component may use one or more of DPAPI, UI Automation and IAccessible2 accessibility APIs, or IWinApi, to identify the source of text. For a Mac operating system, one or more of macOS Accessibility API, Pasteboard API, Apple Events API or CGEvent API may be used, for example.

### 2.3 Report Generation

At block 210, the process is programmed to receive an input signal specifying generating an authorship or provenance report. In response, at block 216, the authorship or provenance report is generated. Report generation can occur using a second software component on the server side, such as authorship reporting instructions 144C of text processor 140, or it can be implemented within one or both of text processing extension 110A and/or text processing extension 110B.

In one embodiment, the reporting instructions 144C are programmed to execute some or all of the following steps to generate an authorship or provenance report:
1. Read successive rows of the provenance table 148.
2. Update a plurality of provenance category values with sums of counts of characters that match the category value. For example, a “Human typed” category stores the sum of all counts or ranges of characters identified in the provenance database as human-typed. This may be done for all provenance types, categories, URLs, and/or service labels captured in the provenance table as the attribution or provenance for a particular row.
3. Optionally report the provenance category for each text unit among all text units in the document, where a text unit is configurably defined as a sentence, paragraph, page, or other unit.
4. Calculate percentages of the total document character count that each provenance category represents. This step enables reporting metrics, such as “10% of your document was human typed.”
5. Optionally calculate a percentage of instances of editing characters (delete, backspace, word delete) in the provenance table and calculate an entropy value or score that indicates a likelihood of human editing versus fraudulent slow typing or the use of software tools to fake human typing. Other embodiments can use other heuristics to avoid fraudulent use of the system.
6. Optionally receive input specifying a sharing operation and automatically generate a share link that points to a complete copy of the document, a timestamp, and the report as a unitary new document. This binds the report to the version of the document that existed at the timestamp. The link can be encrypted.
7. Optionally generate the report as the document is written, for example, by displaying a GUI panel or card near each text unit of a plurality of text units and writing one or more authorship or provenance metrics in the card, continuously updating the values as the document changes. This option provides continuous inspection and authorship reporting concerning the document. In one embodiment, the GUI is programmed with a widget to enable toggling continuous inspection and reporting on or off at any time.

In some embodiments, authorship reporting instructions 144C may be incorporated into one or both of text processing extension 110A and/or text processing extension 110B. In such embodiments, text processing extension 110A and/or text processing extension 110B may operate independently of, and without the presence of, a text processor 140, at least for purposes of determining and reporting provenance.

### 2.4 Graphical User Interface Examples

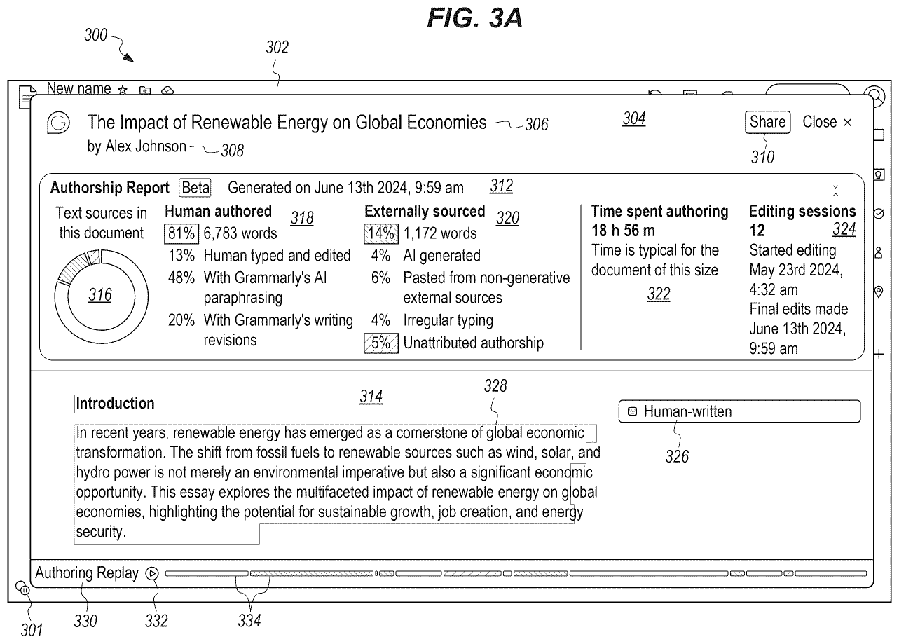

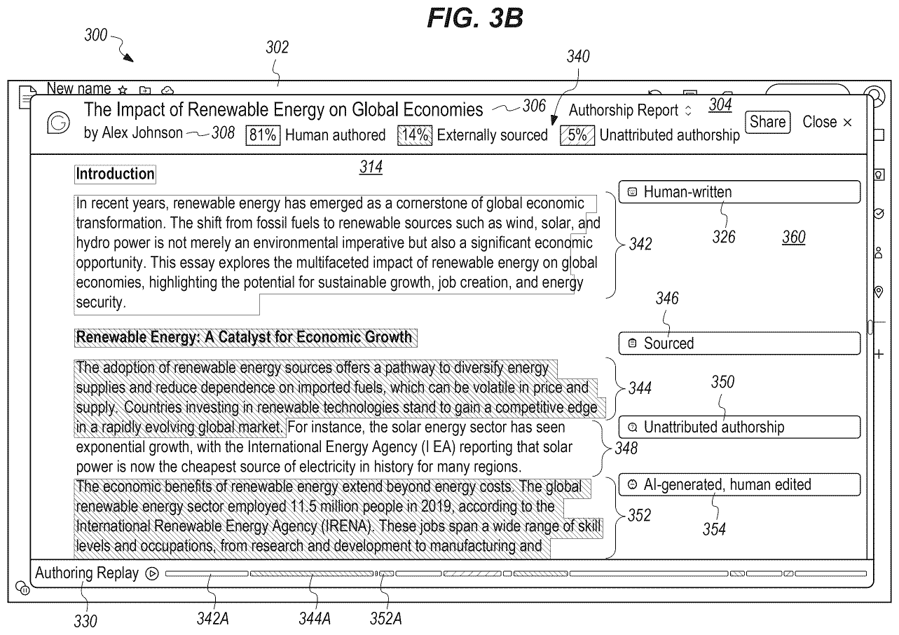

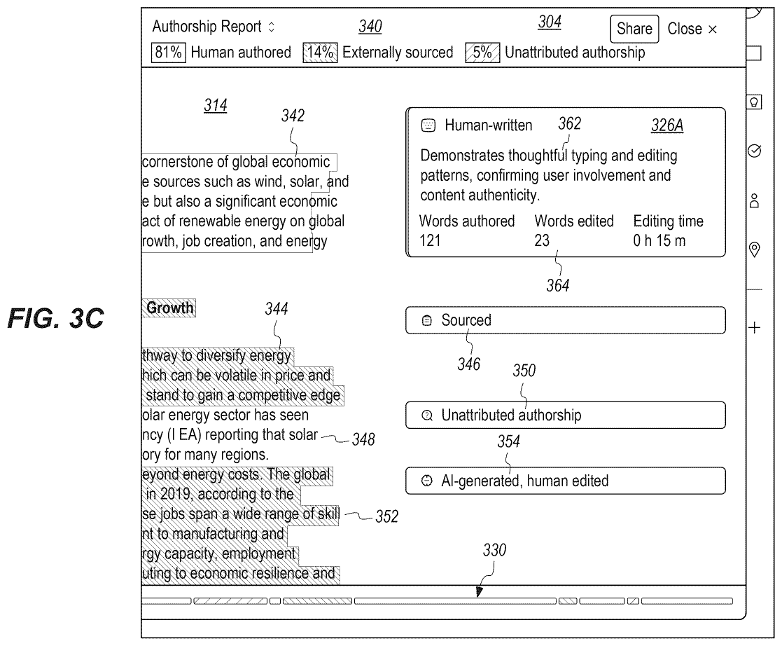

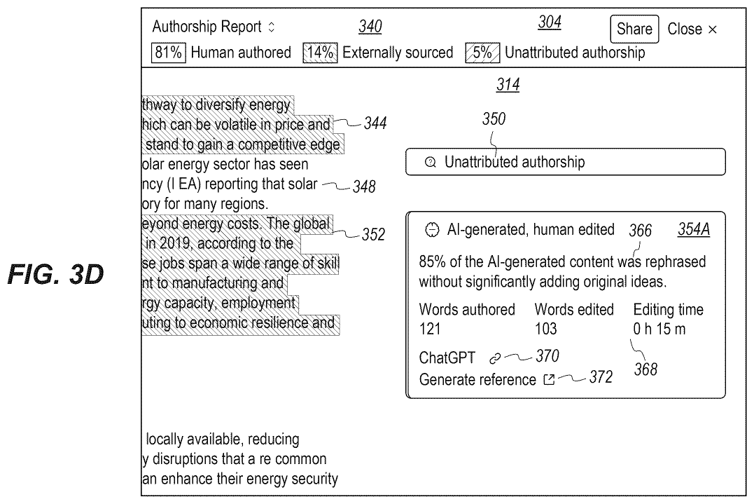

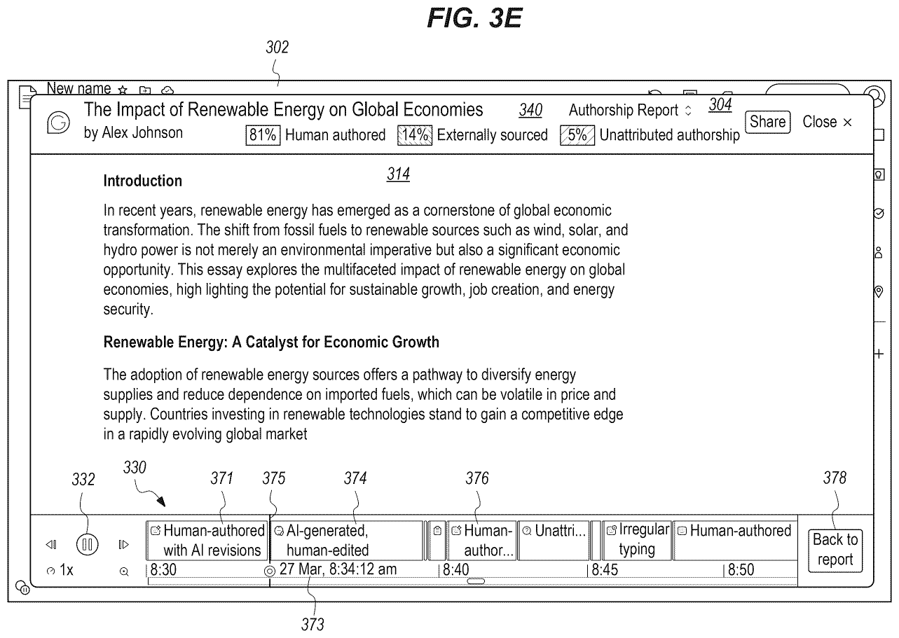

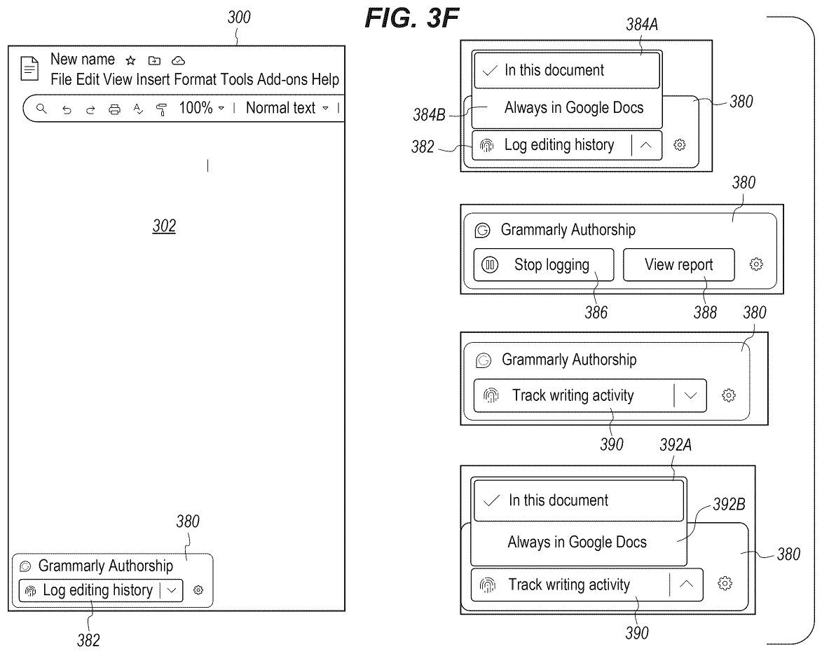

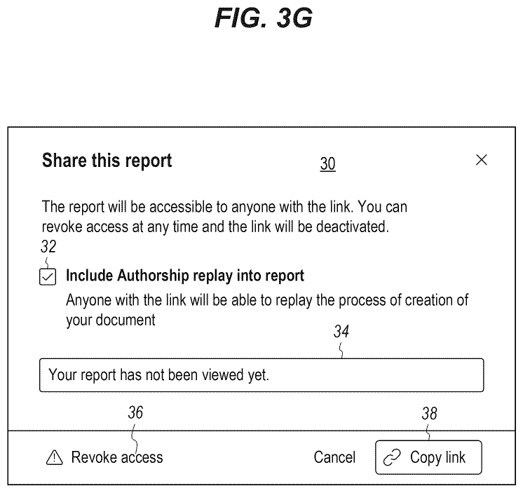

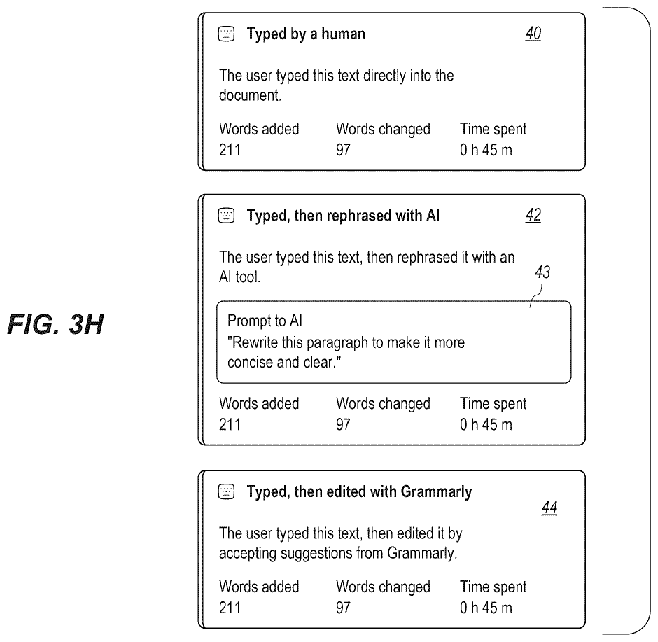

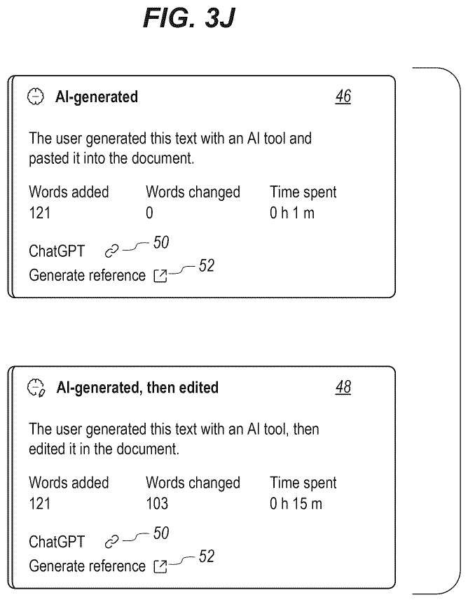

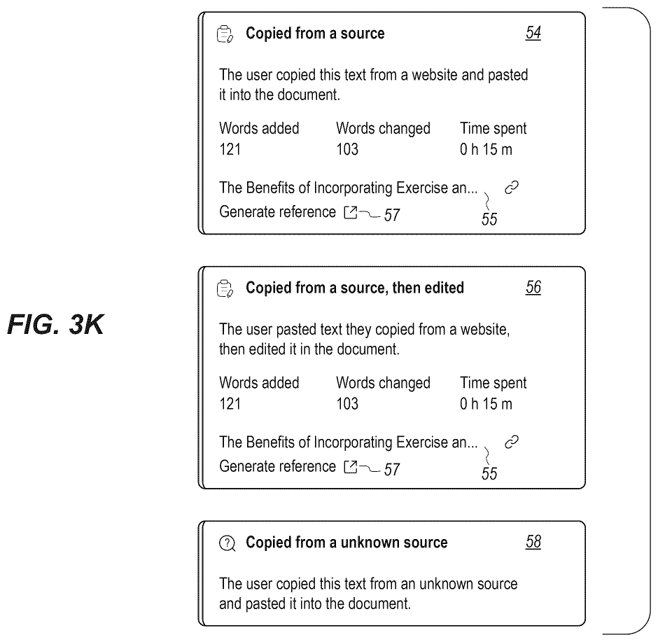

FIG. 3A illustrates an example of a computer display device showing a graphical user interface displaying an authorship report. In an embodiment, report generation instructions 144C drive a computer display device 300 to display an authorship report 304 superimposed over a document window 302 that the browser 108 displays. For example, document window 302 could display a document under preparation via Google Docs or another online web-based document preparation system. In an embodiment, the text extension 110B generates and continuously displays an authorship report control 301 in a position floating over the document window. In response to user input specifying a selection of the authorship report control 301, the text extension 110B is programmed to communicate with the report generation instructions 144C to calculate metrics and receive presentation instructions that can be rendered to display the authorship report 304.

In an embodiment, authorship report 304 is programmed to show a document title 306 and author 308, which can be obtained via calls to the document preparation system to retrieve metadata associated with the then-current document under preparation. In an embodiment, authorship report 304 is programmed to display a data panel 312 and a document panel 314. In an embodiment, the data panel 312 comprises a ring chart 316, one or more provenance panels 318 and 320, a time panel 322, and a session panel 324.

Ring chart 316 comprises a plurality of discrete arc segments, each arc segment corresponding to a provenance category, such as “Human authored” or “Externally sourced,” and each arc segment having a length, along a curvature, proportional to the quantity of authorship in the current document corresponding to the provenance category that the arc segment represents. Specific provenance category labels may vary in different embodiments. Arc segments and provenance category labels can be color-coded or appear using typographical attributes other than color.

In an embodiment, the provenance panels 318 and 320 correspond to individual provenance categories among a small number of main provenance categories. For example, an embodiment can use two, three, or four main provenance categories. Each provenance panel 318 and 320 displays numbers, percentages, counts, and subcategory labels for metrics corresponding to the provenance category. In an embodiment, provenance panel 318 shows metrics for the provenance category “Human-authored” and values for sub-categories such as “Human typed and edited,” “With Grammarly's AI paraphrasing,” and “With Grammarly's writing revisions.” Other embodiments may use different sub-categories. Metrics include the total percentage of the document, the total words corresponding to the category, and the percentage of the document corresponding to each of the sub-categories.

Provenance panel 320 is structured similarly, as shown in the example of FIG. 3A shows metrics for the category “Externally sourced” and the sub-categories “AI generated,” “Pasted from non-generative external sources,” “Irregular typing,” and “Unattributed authorship.”

In an embodiment, time panel 322 displays the total time spent authoring the document. In some embodiments, the total time value can be compared, using report generation instructions 114C, to data stored on the server side, indicating the total time that other users have spent creating or editing other documents of a similar length. That data can be stored in a de-identified or anonymized manner as it represents community values.

In an embodiment, session panel 324 shows a count of the number of editing sessions involved in updating the document, with timestamps for the first session and last session. To generate data for session panel 324, the text extension 110B can be programmed to locally record the timestamps for the first session and last session in memory of computing device 102 and to report the timestamps to the text processor 140 periodically on a de-identified basis.

In an embodiment, document panel 314 comprises a text portion 328 corresponding to a copy of the text entered for the current document in text window 302. Therefore, the document panel positively binds or associates the text of the current document to the authorship report 304 so that the metrics of the authorship report will be understood as accurate only in reference to that version of the document that has been bound or associated. One or more text units of the text portion 328 are displayed using highlighting or other distinctive visual elements in association with a provenance panel link 326. Text units can comprise words, sentences, paragraphs, or pages. In an embodiment, each provenance panel link 326 is programmed as an active link that user input can select to expand into a graphical window, panel, or card showing provenance details corresponding to the associated text units, as shown for subsequent drawing figures.

In an embodiment, authorship report 304 further comprises a replay bar 330 having a play control 332 and a plurality of bar segments 334. The play control 332 can be used to play back a recording of the process of creating the document. Playback may be organized, for example, by provenance category, and then chronologically within each provenance category. Each bar segment 334 corresponds in color or another visual attribute to one of the provenance categories. Each bar segment 334 has a length proportional to the length of a set of text units associated with a particular provenance category. For example, if three paragraphs of the document are associated with the provenance category “Human typed,” the corresponding bar segment could be relatively long, whereas if two sentences were externally sourced, then another bar segment corresponding to those sentences could be short. The replay bar 330 can comprise any number of discrete bar segments depending on the results of analyzing the document's authorship.

FIG. 3B illustrates an example of a computer display device showing a graphical user interface displaying a document with provenance information associated with sentences. FIG. 3B shows device 300, window 302, and authorship report 304 as in FIG. 3A, after a scrolling operation within the authorship report. In response to user input signaling scrolling the authorship report 304, the text extension 110B is programmed to collapse the data panel 312 into a collapsed data panel 340, showing only top-level data metrics for the plurality of main provenance categories. Further, the document title 306 and author are redisplayed in smaller format.

In document panel 314 of FIG. 3B, a plurality of text units 342, 344, 348, and 352 can be highlighted or otherwise displayed with visual attributes corresponding to the main provenance categories. The Document panel 314 further comprises a plurality of provenance panel links 326, 346, 350, and 354 corresponding respectively to a particular text unit among the plurality of text units 342, 344, 348, and 352. Each of the provenance panel links 326, 346, 350, and 354 is visually displayed in a margin 360 of the authorship report 304 and in a vertical position near the top of each particular text unit among the plurality of text units 342, 344, 348, and 352. With this approach, each particular text unit among the plurality of text units 342, 344,348, and 352 is visually associated with a corresponding one of the provenance panel links 326, 346, 350, and 354.

FIG. 3C illustrates an example of a computer display device showing a portion of a graphical user interface displaying a document, a provenance card, and other provenance information. FIG. 3C shows the same authorship report 304, collapsed data panel 340, and text units 342,344,348, and 352 of FIG. 3B. Further, FIG. 3C shows a display state after user input has signaled a selection of the provenance panel link 326. In response to such an input, the text processing extension 110B is programmed to cause displaying a provenance card 326A comprising an explanation 362 and a plurality of provenance data 364 providing explainability and foundation metrics for the provenance card. For example, explanation 362 can comprise a prose statement explaining why the text unit 342 has been determined to correspond to the provenance category “Human-written” of the provenance card 326A. The provenance data 364 can specify words authored, words edited, and editing time for the text unit 342. As in FIG. 3B, in FIG. 3C, the provenance panel links 346, 350, and 354 are shown in a collapsed format as they are not selected.

FIG. 3D illustrates a second example of a computer display device showing a portion of a graphical user interface displaying a document, a provenance card, and other provenance information. FIG. 3D shows the elements of FIG. 3C, but in FIG. 3D, the provenance panel link 354 has been selected, causing the text processing extension 110B to display a provenance card 354A comprising an explanation 366, provenance data 368, service label 370, and reference link 372. Explanation 366 and provenance data 368 operate and provide the information described for similar elements of FIG. 3C. The service label 370 specifies a service from which the corresponding text unit 352 was obtained. The service label 370 can correspond to a value that was looked up in service table 149 (FIG. 1) as previously described in connection with FIG. 1 and FIG. 2. In an embodiment, when the service label 370 specifies a generative artificial intelligence system—ChatGPT in the example—the reference link 372 can be programmed to transmit prompts to an API of the named service to generate a reference from which the text unit 352 was sourced. The resulting reference can be a book, journal article, website, or other source data on which the generative AI system had been trained.

FIG. 3E illustrates an example of a computer display device showing a graphical user interface displaying a document with a graphical authorship bar. FIG. 3E illustrates the elements of FIG. 3B in a state after user input has signaled a selection of the play control 332. In response, the authorship bar 330 is redisplayed using a plurality of bar segments 371, 374, and 376, each corresponding to a text unit of the document shown in document panel 314. Each bar segment 371, 374, and 376 comprises a label specifying one of the main provenance categories. In an embodiment, a play head widget 375 graphically specifies a then-current point of replaying the writer's process of authoring or creating the document and is associated with a timestamp 373. In some embodiments, bar segments 374 and 376, which represent authoring or creating activity later than the value of the timestamp 373, are shown grayed out or with another distinctive visual attribute compared to bar segment 371, which is earlier than the value of the timestamp. With this functionality, a user viewing the authorship report 304 can revisit and visualize the authoring and creating activity of the user, which could lend insight into the overall level of originality or work involved in creating the document. In one embodiment, selecting the play control 332 causes the playback widget to be redisplayed in a different form, such as toggling it to show pause and play icons.

FIG. 3F illustrates an example of computer graphical displays of user interface panels for controlling authorship tracking operations. In one embodiment, device 300 displays document window 302 as previously described; in response to user input to select authorship report control 301 (FIG. 3A), the text processing extension 110B removes the widget and displays an authorship control 380 comprising a log editing widget 382. In an embodiment, user input to select the log editing widget 382 causes redisplaying the widget with pop-up options 384A and 384B to respectively instruct the text processing extension 110B to log the user's editing activity only in the current document (option 384A) or in all documents with the online text processing application (option 384B).

In an embodiment, selecting either of the options 384A and 384B causes the text processing extension 110B to update the authorship control 380 to show a “stop logging” control 386 and “view report” control 388, each of which is programmed as an active link or widget. In response to user input to select the “stop logging” control 386, the text processing extension 110B is programmed to stop recording data in the provenance table 148 (FIG. 1) and to update the authorship control 380 to show its original format or to collapse into the appearance of authorship report control 301. In response to user input to select the “view report” control 388, the text processing extension 110B is programmed to generate a display of the format of FIG. 3A, in which the authorship report 304 is displayed over the then-current document.

FIG. 3F also shows alternative visual renderings of the authorship control 380. In the alternatives, a “track writing activity” widget 390 can be used with options 392A and 392B, similar to options 384A and 384B.

FIG. 3G illustrates an example of a computer display device showing a portion of a graphical user interface with report-sharing controls. In an embodiment, as shown in FIG. 3A, the authorship report 304 can include a “share” control 310. In response to user input signaling a selection of the “share” control 310, the text processing extension 110B is programmed to generate and display a pop-up window or panel over the current document. In an embodiment, a report sharing panel 30 of FIG. 3G is displayed and comprises notification text, a replay link 32, a status notification 34, a revocation link 36, and a copy link 38. In an embodiment, the replay link 32 is programmed as a checkbox widget and, when checked, instructs the text processing extension 110B to include the authorship bar 330 with the replay controls described above in any version of the authorship report 304 shared with others. In an embodiment, the status notification 34 indicates whether another user has viewed a shared report. In an embodiment, the revocation link 36 is programmed to revoke another user's access to the authorship report 304. In an embodiment, copy link 38 is programmed to generate a secure link to the combined document and authorship report 304.

FIG. 3H, FIG. 3J and FIG. 3K illustrate examples of computer-generated graphical cards for displaying authorship data. An authorship card can be associated with a particular text unit, such as a paragraph, sentence or phrase. Referring first to FIG. 3H, in an embodiment, a provenance card 40 can be programmed to specify that a text unit was typed by a human, with a description of that provenance, a count of words added, a count of words changed, and a session time or duration. In an embodiment, a provenance card 42 can be programmed to specify that a human typed a text unit and then rephrased with AI. A prompt field 43 can specify the prompt the user entered to cause the AI system to change the text. In another embodiment, a provenance card 44 can specify that a human entered the text and then edited the text by accepting suggestions from a writing assistant.

Referring now to FIG. 3J, a provenance card 46 can be programmed to specify that a text unit was AI-generated, with a description, metrics, a service label 50, and a reference link 52. Provenance card 46 is generated when analysis of the provenance table 148 indicates that a text unit was sourced from an AI system and then pasted into the document with no changes. The service label 50 and reference link 52 operate as described above in connection with FIG. 3D. In an embodiment, a provenance card 48 can have the same structure as provenance card 46 but can specify that the user edited the AI-generated text after entering it.

Referring now to FIG. 3K, in an embodiment, a provenance card 54 can specify that a text unit was copied from a website and pasted into the document. The provenance card 54 can comprise a description of the provenance, the metrics specified above, a source identifier 55, and a reference link 57. In an embodiment, the source identifier 55 specifies a title associated with a URL where the user copied the text, and reference link 57 is programmed to generate a reference citation corresponding to the source identifier. In an embodiment, a provenance card 56 can specify that a text unit was copied from a website, pasted into a document and edited. Finally, another provenance card 58 can specify that the user copied the text from an unknown source and pasted it, thus specifying that the text unit is unattributed to a particular source.

To support all the above-mentioned embodiments, the text processing extension 110B can be programmed using the rules previously described and/or other logic or algorithms to inspect the provenance table 148, calculate metrics based on the values stored in the table, determine which text units correspond to provenance categories and sub-categories, and associate provenance links or cards with those text units. In this manner, embodiments provide practical applications of computing to solve the problems identified in the Background, e.g., how to automatically track the specific machine operations and user actions that contribute to every part of a document so that generative AI, cut-and-paste operations, and other forms of machine authorship can be determined accurately based on objective criteria rather than inferences. Embodiments provide improved computer functionality, as represented in the algorithm of FIG. 2, the other algorithms and processes described above, and the graphical user interfaces that have been shown, to generate authorship or provenance reports in forms that have not previously existed.

### 3. Implementation Example

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field-programmable gate array (FPGA) that is persistently programmed to perform the techniques or may include at least one general-purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

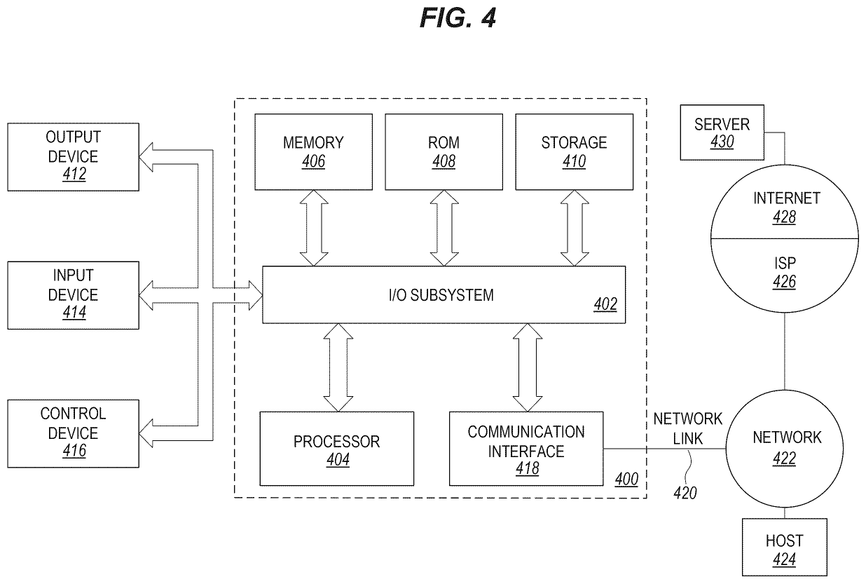

FIG. 4 is a block diagram that illustrates an example computer system with which an embodiment may be implemented. In the example of FIG. 4, a computer system 400 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 400 includes an input/output (I/O) subsystem 402, which may include a bus and/or other communication mechanisms for communicating information and/or instructions between the components of the computer system 400 over electronic signal paths. The I/O subsystem 402 may include an I/O controller, a memory controller, and at least one I/O port. The electronic signal paths are represented schematically in the drawings, for example, as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system, a graphics processing unit (GPU), or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory, such as various forms of random-access memory (RAM) or another dynamic storage device. Memory 406 may also be used for storing temporary variables or other intermediate information during the execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read-only memory (ROM) 408 or other static storage devices coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disks such as CD-ROM or DVD-ROM and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer, such as a relational database system using a structured query language (SQL) or no SQL, an object store, a graph database, a flat-file system, or other data storage.

Computer system 400 may be coupled via I/O subsystem 402 to at least one output device 412. In one embodiment, output device 412 is a digital computer display. Examples of a display that may be used in various embodiments include a touchscreen display, a light-emitting diode (LED) display, a liquid crystal display (LCD), or an e-paper display. Computer system 400 may include another type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators, or servos.

At least one input device 414 is coupled to I/O subsystem 402 for communicating signals, data, command selections, or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on an output device 412 such as a display. The input device may have at least two degrees of freedom in two axes, a first axis (e.g., x) and a second axis (e.g., y), that allows the device to specify positions in a plane. Another type of input device is a wired, wireless, or optical control device, such as a joystick, wand, console, steering wheel, pedal, gearshift mechanism, or another type of control device. An input device 414 may include a combination of multiple input devices, such as a video camera and a depth sensor.

In another embodiment, computer system 400 may comprise an Internet of Things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders, and the output device 412 may complise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server computer 430.

Computer system 400 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid-state drive, flash drive, magnetic data storage medium, any optical or physical data storage medium, memory chip, or the like.

Storage media is distinct from but may be used in conjunction with transmission media. Transmission media pailicipates in transferring information between storage media. For example, transmission media includes coaxial cables, copper wires, and fiber optics, including the wires that comprise a bus of I/O subsystem 402. Transmission media can also take the form of acoustic or light waves, such as those generated during radio-wave and infrared data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal, and appropriate circuitry can provide the data to I/O subsystem 402 and place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to I/O system 402 or a bus. Communication interface 418 provides a two-way data communication coupling to a network link(s) 420 that are directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 422 broadly represents a local area network (LAN), wide-area network (WAN), campus network, internetwork, or any combination thereof. Communication interface 418 may comprise a LAN card to provide a data communication connection to a compatible LAN or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a worldwide packet data communication network represented as Internet 428. A server computer 430 may be coupled to Internet 428. Server computer 430 broadly represents any computer, data center, virtual machine, or virtual computing instance with or without a hypervisor or computer executing a containerized program system such as DOCKER or KUBERNETES. Server computer 430 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 400 and server computer 430 may form elements of a distributed computing system that includes other computers, a processing cluster, a server farm, or other organization of computers that cooperate to perform tasks or execute applications or services. Server computer 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 430 may comprise a web application server that hosts a presentation layer, application layer, and data storage layer, such as a relational database system using a structured query language (SQL) or no SQL, an object store, a graph database, a flat-file system, or other data storage.

Computer system 400 can send messages and receive data and instructions, including program code, through the network(s), network link 420, and communication interface 418. In the Internet example, a server computer 430 might transmit a requested code for an application program through Internet 428, ISP 426, local network 422, and communication interface 418. The received code may be executed by processor 404 as it is received and/or stored in storage 410 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

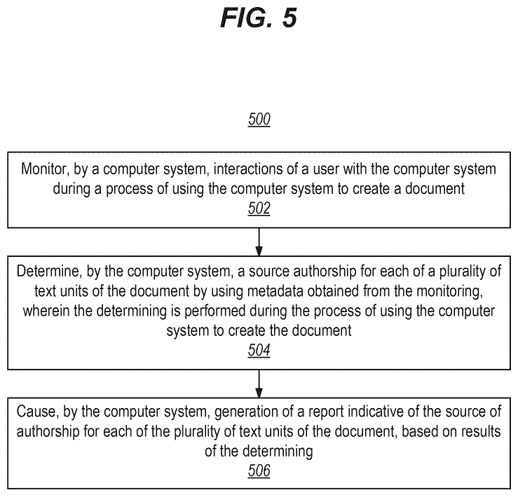

FIG. 5 is a flowchart showing an example of a process 500 in accordance with the technique introduced above. According to an example, one or more process blocks of process 500 may be performed in a computer system, such as computer system 400. As shown in FIG. 5, process 500 includes monitoring, by a computer system, interactions of a user with the computer system during a process of using the computer system to create a document (block 502). Process 500 further includes determining, by the computer system, a source authorship for each of a plurality of text units of the document by using metadata obtained from the monitoring, where the determining is performed during the process of using the computer system to create the document (block 504). Process 500 further includes causing, by the computer system, generation of a report indicative of the source of authorship for each of the plurality of text units of the document, based on results of the determining (block 506). It should be noted that while FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Hence, the following summarizes at least one aspect of the technique introduced above: A computer-implemented process is programmed to determine what systems contributed to the input at the time of creation or composition based on monitoring the technical processes by which the original text was created, for example, by tracking whether each unit of text was typed directly or copied from another source, including but not limited to AI sources. Embodiments are programmed to inspect keystrokes and other events, such as copy-paste operations, external generative artificial intelligence systems, and changes to text via writing assistants. The events, characters, and metadata, such as sources or services, are stored in a provenance table on the user's device. Heuristics and algorithms process the provenance table to derive associations of text units, such as sentences or paragraphs, to specific provenance categories or sub-categories and to generate reports showing the parts and percentages of a document that were human-authored, pasted from a source, or obtained from a generative AI system, enabling objectively accurate assessment and reporting concerning human authorship or lack thereof.

What is claimed is:

1. A method comprising:
monitoring, by a computer system, interactions of a user with the computer system during a process of using the computer system to create a document;
determining, by the computer system, a source authorship for each of a plurality of text units of the document by using metadata obtained from the monitoring, wherein the determining is performed during the process of using the computer system to create the document; and
causing, by the computer system, generation of a report indicative of the source of authorship for each of the plurality of text units of the document, based on results of the determining.

2. The method of claim 1, wherein the monitoring comprises using an API to detect and identify keypresses by the user.

3. The method of claim 2, wherein the monitoring comprises using an accessibility API to detect and identify keypresses by the user.

4. The method of claim 1, wherein the determining the source of authorship of a text unit of the document comprises associating the text unit with a category selected from among a set of categories that includes: human-authored, copies from a website, and AI generated.

5. The method of claim 4, wherein the set of categories further includes acceptance of a suggestion from a writing assistance tool.

6. The method of claim 1, wherein the monitoring comprises tracking a copying and pasting of a text unit of the document from the document to a second document.

7. The method of claim 1, wherein the document is created using a first application, and wherein the monitoring comprises tracking a copying and pasting of a text unit of the document from the first application to a second application.

8. The method of claim 1, wherein the monitoring and the determining are performed while the document is being created using a first software application, the method further comprising:
monitoring, by the computer system, interactions of a user with the computer system during a process of using the computer system to create a second document using a second software application that is different from the first software application;
determining, by the computer system, a source authorship for each of a plurality of text units of the second document; and
causing, by the computer system, generation of a report indicative of the source of authorship for each of the plurality of text units of the second document.

9. The method of claim 1, further comprising generating, by the computer system, a provenance table containing data indicative of the source of authorship for each of the plurality of text units of the document.

10. The method of claim 9, wherein the provenance table comprises a plurality of entries, including a separate entry for each of a plurality of individual characters of text of the document, each entry of the plurality of entries including a timestamp, a character identifier, an ordinal position of a character in the document, and a provenance category assigned to the character.

11. The method of claim 1, wherein the monitoring comprises detecting a copy event representing a copying of text onto a system clipboard of the computer system.

12. The method of claim 11, wherein the determining comprises:
recording a network address of a website accessed by the computer system prior to the copying of the text onto the system clipboard, in response to the computer system accessing the website; and
associating the text with the network address in a provenance table in response to a paste event after the copy event, wherein a portion of the provenance table containing the text associated with the network address is subsequently used to generate the report.

13. The method of claim 12, further comprising:
accessing a stored data structure to identify a service label associated with the network address; and
associating the service label with the text in a provenance table.

14. The method of claim 1, wherein when the determining comprises determining that the source of a unit of text is an output of a generative AI tool, the method further comprises:
storing a prompt that was provided to the generative AI tool to cause generation of the output; and
causing the prompt to be included in the report indicative of the source of authorship in association with the unit of text.

15. A computer system comprising:
at least one processor; and
at least one memory coupled to the at least one processor, the at least one memory storing a first software component programmed to
detect, by using an API of a software component on the computer system, a plurality of text units entered into a document, and
determine a source authorship for each of the plurality of text units, during a process of creating the document, by examining a manner in which each of the plurality of text units was entered into the document.

16. The computer system of claim 15, wherein the at least one memory further stores a second software component programmed to generate a report indicative of the source of authorship for each of the plurality of text units of the document, based on results of determining the source authorship for each of the plurality of text units.

17. The computer system of claim 15, wherein the API is an accessibility API.

18. The computer system of claim 15, wherein to determine the source of authorship comprises:
to record a network address of a website accessed by the computer system prior to a copying of text onto the system clipboard, in response to the computer system accessing the website; and
to associate the text with the network address in a provenance table in response to a paste event after the copying of the text, wherein a portion of the provenance table containing the text associated with the network address is subsequently used to generate a report.

19. At least one non-transitory machine-readable storage medium storing instructions, execution of which by a processor in a computer system causes the computer system to perform a process comprising:
monitoring interactions of a user with the computer system in relation to a process of creating a document, such that the monitoring is performed in real time during the process of creating the document;
determining a source authorship for each of a plurality of text units of the document by using metadata obtained from the monitoring, such that the determining is performed during the process of creating the document; and
causing generation of a report indicative of the source of authorship for each of the plurality of text units of the document, based on results of the determining.

20. The at least one non-transitory machine-readable storage medium of claim 19, such that the monitoring comprises using an API to detect and identify keypresses by the user.

21. The at least one non-transitory machine-readable storage medium of claim 20, further comprising generating, by the computer system, a provenance table containing data indicative of the source of authorship for each of the plurality of text units of the document, such that the provenance table comprises a plurality of entries, including a separate entry for each of a plurality of individual characters of text of the document, each entry of the plurality of entries including a timestamp, a character identifier, an ordinal position of a character in the document, and a provenance category assigned to the character.
